(19) United States
(12) Patent Application Publication
(10) Pub. No.: US 2023/0106088 A1
(43) Pub. Date: Apr. 6, 2023

(54) A SMART MINI BAR SYSTEM AND METHOD THEREOF

(71) Applicant: ISM MAKINE ELEKTRIK SANAYI VE TICARET ANONIM SIRKETI, Manisa (TR)

(72) Inventors: Niyazi SENCAN, Manisa (TR); Muhammet CIL, Manisa (TR)

(21) Appl. No.: 17/048,183

(22) PCT Filed: Oct. 4, 2019
(86) PCT No.: PCT/TR2019/050826

§ 371 Date: Oct. 16, 2020

(51) Int. Cl. F25D 29/00; F25D 27/00; G06Q 10/087; G06T 5/50

(52) U.S. Cl. CPC F25D 29/00; F25D 27/005; G06Q 10/087; G06T 5/50; F25D 2500/06; F25D 2700/02; F25D 2700/06; G06T 2207/20221; G06T 2207/30242

(57) ABSTRACT

A smart mini bar system and method are provided for identification of products in a mini bar, determining number of the products and tracking thereof.

### THE RELATED ART

The invention relates to a smart mini bar system and method for product identification, number detection through product images via a camera placed on cover of the minibar.

The invention particularly relates to a smart mini bar system and method used in hotels and trade ships and capable to conduct real time and prior product analysis by use of virtual intelligence based instant consumption reports and stocks details.

### BACKGROUND OF THE RELATED ART

Today fridges are used to keep foods cold and preserve for longer time. In general, enterprises such as hotels, trade ships prefer mini bars in rooms for use by their customers. The products put therein by hotels are offered to customers in consideration of a payment by customers. During checking out, products consumed by customers are counted by hotel employees and invoiced to the customer. This causes time loss.

In the related art, some fridges have communication panels. Internet technology used for communication with said fridges. However, due to security reasons, Internet access to fridges is restricted by a program installed into fridges.

In the related art a device is located on fridge cover and thus user can see the products in the fridge in the screen provided on cover of fridge without need to open the fridge. This system requires user to update information manually continuously. When person not knowing the system takes a product from the fridge, the product is steel seen in the fridge according to data indicated in the screen on the cover.

The application numbered TR 2014/05178 in the related art discloses a product tracking embodiment by means of transmission of data to internet by a micro auditor used in the fridge and GSP technology. The invention observes instant change in products in the fridge by help of GSM and ethernet module and notifies it to users via internet and/or mobile phone. Micro switches check whether or not products are in the place. However, the invention causes misinformation due to any errors that might arise from micro switches. In addition, said invention does not disclose any information concerning processing and comparison of data received from camera, identification of product details, determination of number and tracking thereof.

Another document in the related art is the application numbered WO2017041263 and it discloses a camera for displaying storing conditions of fridge cabin in details. The system comprises a LED light on each part of cabin compartment. The invention provides observation of status of products in the fridge without need for opening the fridge. However, the invention does not recognize products in the fridge and product tracking as it is not a virtual intelligence based.

In conclusion, developments have been made in smart mini bar system and methods and, therefore, new embodiments eliminating the above disadvantages and offering solutions to existing systems are needed.

### PURPOSE OF THE INVENTION

The present invention relates to a smart mini bar system and method meeting the needs mentioned above, eliminating all disadvantages and providing some additional advantages.

Primary purpose of the invention is to disclose a smart mini bar system and method providing identification of products for consumption and stock details thereof in mini bar by receiving inside image of mini bar by camera, determining number and tracking thereof.

Another purpose of the invention is to disclose a smart mini bar system and method determining the products consumed by guest of the room where smart mini bar is during his/her stay.

A further purpose of the invention is to disclose a smart mini bar system and method providing list of products needed to be put in mini bar by enterprise employees based on received information.

Another purpose of the invention is to disclose a smart mini bar system and method providing detailed data to enterprises using smart mini bars by means of data analysis.

In order to achieve all advantages mentioned above and to be understood better with the detailed identification given below, this present invention is a smart mini bar system providing identification of products in a mini bar, determining number and tracking thereof and comprises
at least one camera taking image of interior of the mini bar,
at least one lighting unit located on mini bar cover and lighting the interior of the mini bar so that providing the camera takes image,
at least one distance sensor detecting the status of mini bar cover is open or closed,
at least one processor, detecting by said distance sensor whether the mini bar cover is open or closed; providing the camera takes image when a signal indicating that mini bar cover is close is received; controlling the lighting unit and receiving images from the camera,
at least one server to which the processor transmits images from the camera and where the received images are analysed,
Software provided in the server and providing analysis of images received from the processor and identifying the products and determining their numbers based on result of analysis and comparison of such data to prior data,
a database provided in the server and storing the data of how many and which products there are and what consumed in which mini bar,
at least one indicator board displaying number of the mini bars, number of the products, types of the products, date, time information via user's web, mobile client and where the information of the products in the mini bar can be changed.

In addition, the invention is a smart mini bar method providing identification of products in a mini bar, determining number of products and tracking thereof and comprising process steps of
receipt of data that mini bar cover is closed by the processor from the distance sensor which detecting whether mini bar cover is open or closed,
lighting interior of the mini bar by the processor through lighting unit for enabling the camera to take image,
taking image of interior of the mini bar by the camera located inside the mini bar,
transmission of received image to the server by the processor,
comparison of number and information of the products to prior number and information of the products by means of processing of the image in the server by software,
storing analysis results in database,
display of analysis results in web, mobile or client medium from indicator board.

The structural and characteristic features and all advantages of the invention will be understood better in the figures given below and the detailed identification by reference to the figures. Therefore, the assessment should be made based on the figures and considering the detailed identifications.

### BRIEF DESCRIPTION OF FIGURES

In order to make the embodiment and additional members being subject of the present invention as well as the advantages clearer for better understanding, it should be assessed with reference to the following described figures.

FIG. 1 is illustrative view of smart mini bar system of the invention.

FIG. 2 is view of camera position of the smart mini bar system of the invention.

FIG. 3 is shelf view of smart mini bar system of the invention.

FIG. 4 is shelf side view of smart mini bar system of the invention.

### REFERENCE NUMBERS

1. Mini bar
2. Server
3. Software
4. Indicator board
5. Database
6. Camera
7. Processor
8. Lighting unit
9. Internet
10. Distance sensor
11. Shelf

### DETAILED DESCRIPTION OF THE INVENTION

In this detailed identification, a smart mini bar system and method building being subject of this invention and the preferred embodiments have been disclosed solely for the purpose of better understanding of the subject and described in a manner not causing any restrictive effect.

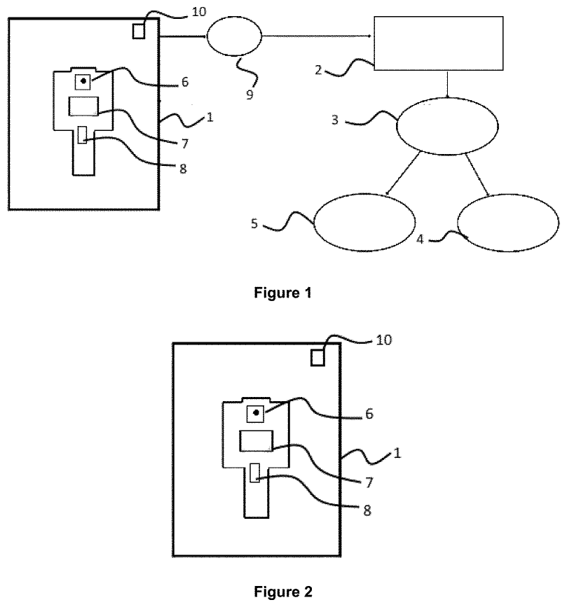

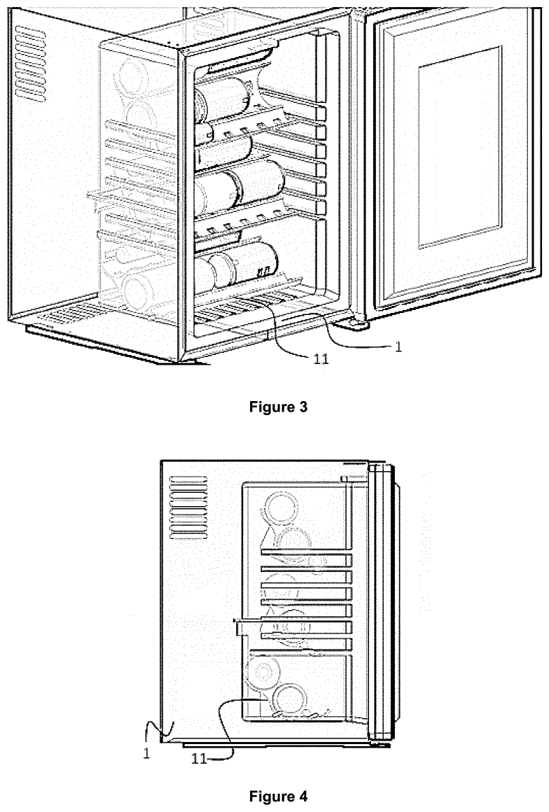

FIG. 1 is illustrative flow diagram view of smart mini bar system of the invention. System basically comprises a server (2), software (3), indicator board (4), database (5), camera (6), processor (7), lighting unit (8), distance sensor (10). It comprises at least one lighting unit (8) illuminating inside of the mini bar for clear display of products inside the mini bar (1) keeping food cold. Inside of mini bar (1) is displayed by means of at least one camera (6) fixed inside mini bar. It comprises a processor (7) transmitting the images taken by the camera (6) to the section where they are analysed. A server (2) receives images from the processor (2) and analyzes received images.

The images taken by the camera (6) are transmitted to the server (2) via Internet (9) or cloud technology. The server (2) comprises a software (3) analyzing the images received from the processor (7) and database (5) where data about the quantity of which products in which mini bar (1) are stored. Number of mini bar (1) analyzed by the server (2), number, types of products, date and time information are displayed on indicator board (4) through user's web, mobile client. In addition, product stock details can also be changed from said indicator board (4). Distance sensor (10) detects if the mini bar (1) cover is open or close and transmits it to the client (7) and image taking process is started when cover is close.

In a preferred embodiment of the invention, the said lighting unit (8) is a LED.

The camera (6) used in the invention is programmed in a manner not infringing personal data protection requirements. The camera (6) takes images only when mini bar (1) cover is close.

System requirements are as follows:

5 V/2.5 A DC power input
Processor power up to 64-bit 1.4 GHz
GPIO cap
2.4 GHz and 5 GHz IEEE 802.11.b/g/n/ac wireless LAN

A smart mini bar method providing identification of products in a mini bar (1), determining number and tracking of products starts with receipt of information by server (7) from distance sensor (10) that mini bar (1) cover is close. Then the lighting unit (8) illuminates inside of the mini bar (1) upon command from the processor (7) to enable camera (6) to take image and camera (6) takes image of inside of the bar (1). The received image is transmitted to the server (2) by the processor (7) and the image in the server (2) is processed by help of software (3) and number and information of product is compared to number and information of prior image. Thus, number of used/consumed products can be found out. Deep network model is used for processing images received by said camera (6). The network can be trained by means of products data defined into software before.

Analysis results and records are stored in database (5) and the data can be used for both products tracking and comparison of next image receiving. In addition, analysis results can also be displayed in web, mobile or client medium from indicator board (4). Said indicator board (4) can be closed whenever requested by user. In such case system is turned off and no imaging can be made.

It comprises at least one shelf (11) inside mini bar (7) whereon products are placed, and which is designed in a manner all products can be seen by the camera (6). In a preferred embodiment of the invention, in the system comprising more than one shelf (11), images taken separately from each shelf (11) are combined in the processor (7) and joined into one single image. Thus, image server (2) transmission efficiency is enhanced and faster and more effective transmission by server (2) is provided.

In a preferred application of the invention, data exchange between said camera (6), processor (7) and server (2) is provided via internet (9) or cloud.

1. A smart mini bar system providing identification of products in a mini bar, determining number of the products and tracking thereof, the system comprising:
at least one camera taking image of an interior of the mini bar;
at least one lighting unit located on a mini bar cover and lighting the interior of the mini bar so that providing the camera takes image;
at least one distance sensor detecting the status of the mini bar cover is open or closed;
at least one processor, detecting by said distance sensor whether the mini bar cover is open or closed; providing the camera takes image when a signal indicating that mini bar cover is close is received; controlling the lighting unit and receiving images from the camera;
at least one server to which the processor transmits images from the camera and where the received images are analysed;
software provided in the server and providing analysis of images received from the processor and identifying the products and determining their numbers based on result of analysis and comparison of such data to prior data;
a database provided in the server and storing the data of how many and which products there are in which mini bar; and
at least one indicator board displaying number of the mini bars, number of the products, types of the products, date, time information via user's web, mobile client and where the information of the products in the mini bar can be changed.

2. The smart mini bar system according to claim 1, wherein said lighting unit is LED.

3. A smart mini bar method providing identification of products in a mini bar, determining number of products and tracking thereof characterized in comprising process steps of:
receipt of data that the mini bar cover is closed by the processor from the distance sensor which detecting whether mini bar cover is open or closed;
lighting interior of the mini bar by the processor through lighting unit for enabling the camera to take image;
taking image of interior of the mini bar by the camera located inside the mini bar;
transmission of received image to the server by the processor;
comparison of number and information of the products to prior number and information of the products by means of processing of the image in the server by the softwares;
storing analysis results in database; and
display of analysis results in web, mobile or client medium from indicator board.

4. The smart bar method according to claim 3, characterized in comprising the process step of combining images taken separately from each shelf in systems having more than one shelf and joining them into one single image on the processor.

5. The mini bar method according to claim 3, characterized that data exchange between the camera, the processor and the server is provided via internet or cloud.
